(19) United States
(12) Patent Application Publication
(10) Pub. No.: US 2014/0130059 A1
(43) Pub. Date: May 8, 2014

(54) Lattice Computing

(71) Applicant: Rational Systems LLC, Houston, TX (US)

(72) Inventor: Nicholas Mark Goodman, San Mateo, CA (US)

(73) Assignee: Rational Systems LLC, Houston, TX (US)

(21) Appl. No.: 14/071,646

(22) Filed: Nov. 5, 2013

Related U.S. Application Data
(60) Provisional application No. 61/722,606, filed on Nov. 5, 2012.
(60) Provisional application No. 61/722,585, filed on Nov. 5, 2012.
(60) Provisional application No. 61/722,615, filed on Nov. 5, 2012.

(51) Int. Cl. G06F 9/48

(52) U.S. Cl. CPC G06F 9/4881
USPC 718/106

(57) ABSTRACT

This invention relates to a machine implemented method of executing CPU instructions on a plurality of computers in one or more locations, logically arranged in a weighted, lattice-like structure representing information about CPUs, CPU cores, operating system threads, network interconnects, and computer locations in a many-to-many relationship. This approach, by weighting nodes and costing edges, provides a natural method for commoditizing the execution of a workload. Furthermore, this approach lends itself to a means of determining the incremental value (or cost) of additional nodes. Consequently, the creation of a virtual crowd-sourcing market—in which either CPUs singularly or lattices as a whole are market participants—is a natural extension of the method.

This application claims the benefit of the following commonly-owned co-pending provisional applications: Ser. No. 61/722,585, “Offloading of CPU Execution”; Ser. No. 61/722,606, “Parallel Execution Framework”; and Ser. No. 61/722,615, “Lattice Computing”; with the inventor of each being Nicholas M. Goodman, and all filed Nov. 5, 2012. All of these provisional applications are incorporated by reference, in their entirety, into this application.

This application is one of three commonly-owned non-provisional applications being filed simultaneously, each claiming the benefit of the above-referenced provisional applications, with the inventor of each being Nicholas M. Goodman. The specification and drawings of each of the other two non-provisional applications are incorporated by reference into this specification. One of them, entitled “Parallel Execution Framework,” is cited in places below.

### 1. BACKGROUND OF THE INVENTION

This invention relates to an improved method for performing large numbers of computations involving a great deal of data. See the Background section of the Parallel Execution Framework application for additional discussion.

### 2. SUMMARY OF THE INVENTION

This invention relates to a machine implemented method of executing CPU instructions on a plurality of computers in one or more locations, logically arranged in a weighted, lattice-like structure representing information about CPUs, CPU cores, operating system threads, network interconnects, and computer locations in a many-to-many relationship. Each computer contains one or more CPUs, each having one or more CPU cores. Each node in the lattice is associated with a weight. The lattice may be “unweighted” by applying an equal weight to all nodes. This approach, by weighting nodes and costing edges provides a natural method for commoditizing the execution of a workload. Furthermore, this approach lends itself to a means of determining the incremental value (or cost) of additional nodes. Consequently, the creation of a virtual crowd-sourcing market—in which either CPUs singularly or lattices as a whole are market participants—is a natural extension of the lattice computing method.

### 3. BRIEF DESCRIPTION OF THE DRAWINGS

FIG. 1 is a flattened schematic diagram of a three-dimensional lattice structure, which is shown in an approximate 3D rendering in FIG. 2.

### 4. DETAILED DESCRIPTION OF SPECIFIC EMBODIMENTS

Lattice computing relates to an idea I had while investigating ways of more-effectively parallelizing business code. I think of it as somewhat like the political-cell concept in chapter 9 of Robert A. Heinlein's novel, The Moon is a Harsh Mistress, which has been explained by one reader of the novel at groups dot google dot com slash forum slash #!topic slash alt dot fan dot Heinlein slash dqb0BHIBsj4 as well as illustrated by another reader at www dot ics dot uci dot edu slash ~eppstein slash junkyard slash robertd slash tetrarray dot gif (Per USPTO policy, the foregoing URLs have been edited to prevent them from becoming clickable links on the USPTO Web site if this application is published; the edited links are provided for convenient reference, and neither the inventor nor the applicant vouches for the accuracy of those readers' depictions.)

Here, the lattice is a logical arrangement of computer systems in a multi-level structure that is roughly pyramid shaped (i.e., it is small at the top and gets bigger as it approaches the bottom).

### Overview of Lattice Structure

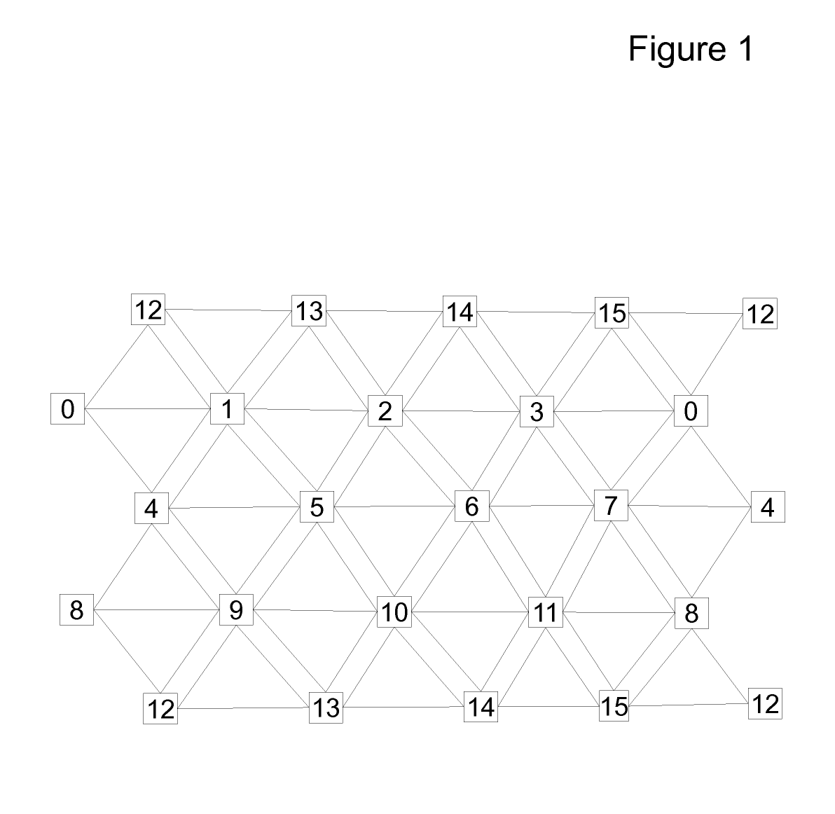

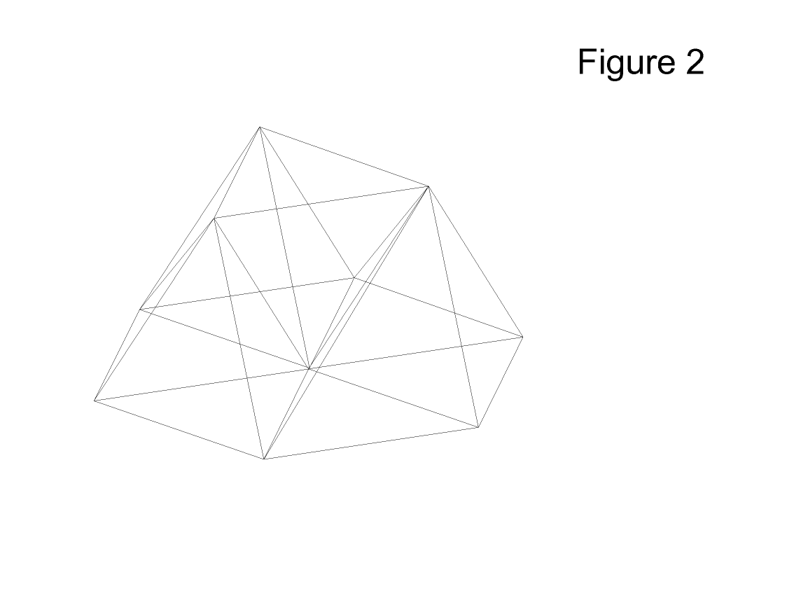

FIG. 1 is a flattened representation of a three-dimensional lattice (shown in an approximate 3D rendering in FIG. 2) in which each of 16 nodes represents a computer system. The nodes are numbered 0 through 15; the corresponding computer systems (sometimes referred to themselves as “nodes” for convenience) are logically grouped into three-member committees. (Because of the flattening of the 3D-structure in FIG. 1, each of the nodes along the perimeter of the lattice, for example nodes 0, 12, 13, 14, etc., are shown twice.)

In this structure, each computer system is a member of six committees. For example, node 2 is in the following six committees:

nodes 13, 1, 2

nodes 1, 5, 2

nodes 13, 14, 2

nodes 3, 14, 2

nodes 3, 6, 2,

nodes 5, 6, 2

In each of these committees, node 2 has one of three total votes (since there are three computers in the committee).

The hardware and basic operating software of each computer system is conventional; any or all could take the form of, for example a Windows, Macintosh, Unix, or GNU/Linux machine, possibly rack-mounted. One or more of such machines could include single- or, more likely, multiple-core central processing units (CPUs). One or more such machines could also be implemented by renting computing capacity on a suitable “cloud” system such as the well-known Amazon Web Services (AWS).

The various nodes may reside in the same physical location and be connected via one or more conventional Ethernet networks, or they may reside in multiple locations and be connected via a conventional wide-area network or via a conventional Internet connection. Other connection possibilities will of course be apparent to those of ordinary skill having the benefit of this disclosure.

In some implementations, it might be desirable to implement one or more of the nodes as multiple, or even many, machines, for example in a conventional clustered- or parallel architecture. A distributed architecture, with different machines in different physical locations, might also be desired for increased robustness, reliability, processing power, redundancy, and so forth.

It will be apparent to one of ordinary skill having the benefit of this disclosure that any of the nodes in the lattice could easily represent a cluster of computer systems as opposed to a single computer system, with one or more of those computer systems exposing an interface via which other nodes can communicate with the cluster node.

The various software programs controlling the nodes might treat any one of the CPUs and/or cores, or some combination thereof, as a separate computer using any of a variety of well-known multi-threading approaches.

Throughout this document, I refer to CPUs, but the concept applies equally well to Graphics Processing Units (GPUs) and to the combination of CPUs and GPUs.

The computer systems comprising the nodes may already be connected in the lattice-like structure, or one or more of them may join the lattice arrangement after computation has begun. The software controlling the lattice-member nodes systems can define “hooks” or “interfaces” for new nodes to join. This could be implemented as an XML- or JSON-based web service that allows one or more computer systems to join an existing lattice. Each new node may be required to expose a TCP/IP port or, alternatively, to expose a web service itself. The latter approach might be desirable if the joining nodes are in a remote location from some or all of the existing nodes in the lattice.

Under this definition of a lattice, each non-trivial lattice (having more than one node) is composed of sub-lattices, each of which may have its own performance characteristics. These characteristics may change over time and may be workload dependent (i.e., some workloads may be more hard-drive intensive or more CPU cache intensive than others).

In addition to weighted nodes, the lattice may include weighted edges, wherein each edge cost represents the transmission cost and/or reliability of the interconnect between the nodes. This edge cost provides a simple method of optimizing communication cost (i.e., cheaper cost is better).

### Division of Labor

One or more nodes accepts respective sets of atomic units of work (see the Parallel Execution Framework application for a more-detailed discussion); each of these nodes is referred to herein as a “root node.” Depending on the implementation, every node could be a root node.

Units of work may be ordered or unordered. Units of work may be of equal or unequal duration or complexity.

Each root node divides the work it accepted among itself (that work, if any, being referred to as the root node's “retained work”) and/or its connected nodes and transmits corresponding work requests to those nodes. The work could be divided into potentially overlapping subsets. The work could also be divided based upon the weights of connected nodes.

Each node may be weighted according to the computing power, reliability, and network speed of the computer represented by the node; the value of the weight can be transmitted to the node's root node or -nodes, as well as to other nodes.

A root node might give more or less work to a single node or to a set of nodes based upon the weight (i.e., a higher weight could indicate that a node can be relied upon to complete more work).

As mentioned above, one or more sets of nodes within the lattice can be considered as being analogous to committees. Each committee member has strengths and weaknesses; members might or might not know each other's strengths and weaknesses to any significant extent, and there might or might not be a chairman.

Following this analogy, the assignment of work within the committee-node may take one of several forms. For example, the chairman, if one exists, might designate one or more nodes to perform a task; the nodes might vote to decide which of them will work on a task; the first node to the work might inform the committee that it has taken work; the committee might designate one or more subcommittees of one or more nodes to work on a designated task; the use of redundant subcommittees would provide a way of determining if an answer or result were “correct.”

As an implementation detail, the node or nodes receiving a work order might choose not to perform the work. This refusal might be polite (i.e., sending a message back to the requestor indicating that the work cannot be done at this time), or it might be rude (i.e., ignoring the request and sending no response).

Committees might work together in conventional fashion; for example, a series of committees of nodes might work on related problems (or even the same problem) and share their results.

Depending upon the implementation, it might make sense to apply some optimization algorithm to the distribution of work. There are many algorithms that could be applied, such as, for example, Network Simplex, the Ford-Fulkerson Max-Flow-Min-Cut algorithm, or a customized numerical constrained convex optimization. Simpler algorithms such as a shortest path algorithm (e.g., Dijkstra's algorithm) might be a better fit if an exactly optimal subdivision of labor were not needed.

The transmission of work and information between nodes might be implemented in several ways, such as a web service; a direct TCP/IP or UDP socket connection; or a database; for performance reasons, a database could be prohibitively expensive, but it might be appropriate for some applications, especially if the database were implemented with a parallel file system such as the Andrew File System (AFS) of the Parallel Virtual File System (PVFS).

Additionally, it should be apparent to one of ordinary skill having the benefit of this disclosure that for some sets of work the network bandwidth, latency, and reliability might be a critical consideration in deciding how to allocate the work. Thus, the use of faster (e.g., InfiniBand, Gigabit Ethernet) for local connections and slower (e.g., the public internet, dedicated, cross-country, fibre lines) for non-local connections should drive the cost of the lattice edges: slow connections should be more expensive and fast connections should be less expensive. This observation should also identify a means of logically subdividing work to reduce network overhead.

It will be apparent to one of ordinary skill having the benefit of this disclosure that a logical method of dividing computers into committees would be to treat each set of computers on a single network switch as a committee and to treat each computer having multiple CPUs and multiple CPU cores as a subcommittee thereof. It might also be logical to divide every set of three nodes on a single switch into a committee.

Each node receiving a set of work units performs the operations described above for those work units, other than its retained work units, until the set of work units has been distributed throughout the lattice as far as it will go. Any given node might do work, though some nodes might be configured to manage other nodes and do no work themselves.

Each node retrieves and executes one unit of work from its retained work set, if any, until it has no more work.

Each node can manage its own work depending upon its own resources and capabilities. If the node represents a cluster, this might involve the execution of a parallel program using a conventional parallel methodology such as, for example, the Message Passing Interface (MPI), OpenMP, or SMP computing.

A given node might receive work from multiple sources; it might be told an order in which to perform the work; or the details might be left to the node. In the last case, the node might assign priority based upon the time the work was received (i.e., a first-in first-out, FIFO, technique). Alternatively, the node might assign priority to the work based upon its source (thinking back to the committee analogy, some committees might be more important than others).

Note that a root node might be both a sender and receiver of work. Depending upon the implementation, a root node might have no special task other than distributing (informing) its sibling nodes of the set of work.

Upon completion of an entire retained work set, a node, referred to hereafter as a “work-seeking node,” searches the lattice for more work by sending a message to each node in turn in the lattice until it finds a node, referred to hereafter as a “work-delegating node,” that can give it a work set. If there exists a work-delegating node, the work-delegating node transmits back to the work-seeking node a non-empty portion of the work-delegating node's own work set. If the work-seeking node receives a work set in response to its request, it executes the work as described above.

If no nodes can give the sending node work; the sending node goes into a waiting state and waits for further work.

In a variation, the root node computes an optimal division the work based upon the weights of nodes in the lattice.

In another variation, the lattice links are weighted based upon the communication cost of sending data between the start node and end node on the link. The root node computes an optimal division the work based upon the weights of nodes in the lattice and/or the weights of links in the lattice. The work-seeking-node searches the lattice for more work by sending a message to each node in turn, ordered by the shortest path by link weight, in the lattice until it finds a work-delegating node.

### Advantages and Possible Other Variations

The lattice structure has two major advantages over existing scheduling mechanisms: Dynamic load balancing, and failure recovery.

Dynamic load balancing is of fundamental importance when the workload cannot be partitioned equally (or near equally). Many parallel algorithms in scientific and engineering computing require near-equal load balancing to achieve fast parallel performance; this is because of dependencies between data.

Take, for example, a Poisson partial differential heat transfer equation discretized with a five-point stencil. The matrix of this discretization is block symmetric with two types of block: (i) an inner block with a 4 on the diagonal and a −1 on the first off diagonal in both directions and (ii) an outer block with a −1 on the diagonal. An outer block is located to the left and right of the inner block in the matrix. This is not a true symmetric matrix, but it is very nearly one.

Because of the near-symmetry of the described matrix, Krylov subspace methods such as the Conjugate Gradient Method and the Generalized Minimal Residual (GMRES) method are effective at providing an iterative, numerical solution to the underlying problem. These methods are desirable because they are parallelizable (i.e., one can execute them on many CPU cores instead of just one). The parallel efficiency of the parallel implementations of these methods, though, is based on the fact that the work each processor does is roughly equal. The method is only as fast as its slowest portion.

This near-equal partitioning is often not possible with many types of computation. This is because real-world data is often a long-tail distribution (a Zipf distribution). Consequently, static load balancing cannot effectively process such data. Dynamic load balancing is the answer.

Dynamic load balancing can take many forms, but the lattice-computing dynamic load balancing concept is that any time a group of siblings runs out of work to perform, it requests work from somewhere else in the lattice. It starts requesting this work from nearby groups of siblings and expands outward until there is no remaining work.

This method is also highly reliable because it places responsibility for work with a group of nodes, each of which will take over if other nodes fail. If there is widespread failure (e.g., a data center goes out), all of the work that is missing can be rescheduled by the parent nodes. In practice, this requires having many data centers or locations, otherwise the failure of one data center could remove a large portion of nodes.

Consider, for example, the loss of a datacenter which contains 10% of the nodes in the lattice. An intelligent structuring of the lattice would provide for such a loss by keeping a copy of the work done by that data center (or at least a means of obtaining it) in one or more other data centers. Then, upon the loss of the one data center, any data center containing the copy could transmit that work (or the means of obtaining it) to another data center. Then, among the data centers having a way of executing the lost work, the committees can decide upon a partition of the data set.

To guard against work being lost, each committee is responsible for the set of work each committee member does (keep in mind that a committee may be composed of committees). Thus, the committee uses a method, such as periodic polling or a periodic heartbeat, to ensure that all of its nodes are online. If a node goes offline, the committee decides upon a means of recovering (generally shuffling the work to another committee member). If too many of the committee members go offline, the committee may send a message to its parent committee requesting less work or more nodes.

If nodes in the lattice do not truly fail but are just disconnected, this structure lends itself to self repair in the event that the connection is regained.

It would be reasonable to presume that the lattice methodology could be deployed to manage sub-core computational groups of qubits working together in committees in future quantum computers.

See also part 5 of the Parallel Execution Framework application, which reproduces two graduate-school papers that I wrote on this and related subjects.

### Programming

### Program Storage Device

The system and method described may be implemented by programming suitable general-purpose computers to function as the various server- and client machines shown in the drawing figures and described above. The programming may be accomplished through the use of one or more program storage devices readable by the relevant computer, either locally or remotely, where each program storage device encodes all or a portion of a program of instructions executable by the computer for performing the operations described above. The specific programming is conventional and can be readily implemented by those of ordinary skill having the benefit of this disclosure. A program storage device may take the form of, e.g., a hard disk drive, a flash drive, another network server (possibly accessible via Internet download), or other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

### Alternatives

The above description of specific embodiments is not intended to limit the claims below. Those of ordinary skill having the benefit of this disclosure will recognize that modifications and variations are possible; for example, some of the specific actions described above might be capable of being performed in a different order.

I claim:

1. A machine implemented method of executing CPU instructions on a plurality of computers in one or more locations, comprising:
(a) a set of multiple computers is provided, with the computers being connected by communications links in a generally-pyramidal, lattice-like structure, referred to as the “lattice”; each such computer is referred to as a “node” in the lattice;
(b) each of a plurality of nodes in the lattice, referred to as “root nodes,” executes a program of instructions causing the root node to accept or reject requests to perform sets of atomic units of work that are sent to it from other nodes in the lattice;
(c) a specified root node accepts one or more units of work from one or more other nodes in the lattice;
(d) the specified root node retains for itself zero or more portions, but less than all such portions, of the work it accepted (referred to as that root node's “retained work”), and adds that retained work to a set of zero or more work units for that root node, referred to as that root node's “retained work set”;
(e) the specified root node allocates the remaining portions of the work it accepted among one or more other nodes in the lattice, each referred to as a “target node,” and sends corresponding work requests to each of the one or more target nodes;
(f) the operations referred to in subparagraphs (d) and (e) are referred to as the specified root node's “dividing” the work it accepted;
(g) IF: a target node accepts a work request it receives from the specified root node; THEN: that target node divides that work among itself and zero or more target nodes as described in subdivisions (d) and (e);
(h) the operations described in subdivisions (d), (e), and (g) are performed successively by different nodes in the lattice until all portions of the work accepted by the specified root node in subdivision (c) have been distributed to the respective retained work sets of various nodes in the lattice, referred to as “working nodes”;
(i) each working node performs its retained work, possibly while the operations described in subdivisions (d), (e), and (g) are in progress;
(j) when a working node, referred to as a “work-seeking node,” completes the work in its retained work sets, the work-seeking node sends a work-seeking message to each of one or more other nodes in the lattice in turn, in search of a node, referred to as a “work-delegating node,” that can give the work-seeking node more work to do;
(k) IF: such a work-delegating node exists; THEN: that work-delegating node sends back to the working-seeking node a request to perform work corresponding to a non-empty portion of the work-delegating node's own retained work set;
(l) IF: the work-seeking node receives more work to do in response to a work-seeking request message; THEN: the work-seeking node performs the operations described in subdivisions (d), (e), and (g); and
(m) If no nodes give work to the work-seeking node, then that sending node goes into a waiting state and waits for further work requests.

2. The method of claim 1, in which (i) one or more nodes in the lattice is assigned a weight as an indicator of its capacity for work; and (ii) the root node computes a preferred division of work among one or more such nodes based upon the nodes' respective assigned weights.

3. The method of claim 2, in which:
(i) each of the lattices' communications links is assigned a weight based upon the communication cost of sending data across that link; and
(ii) the root node computes a preferred division of work based upon the weights of nodes in the lattice and/or the weights of links in the lattice.

4. The method of claim 1, in which the various worker computer systems reside in more than one physical location.

7. A program storage device readable by a computer system, containing a machine-readable description of instructions for the computer system to perform the operations of a specified node described in claim 1.
